(19) United States
(12) Patent Application Publication
(10) Pub. No.: US 2013/0048436 A1
(43) Pub. Date: Feb. 28, 2013

(54) AUTOMATED ELEVATOR CAR CALL PROMPTING

(71) Applicant: Mark Kit Jiun Chan, Hong Kong (CN)

(72) Inventor: Mark Kit Jiun Chan, Hong Kong (CN)

(21) Appl. No.: 13/219,921

(22) Filed: Aug. 29, 2011

(51) Int. Cl. B66B 1/18

(52) U.S. Cl. 187/387

(57) ABSTRACT

A method for automatically prompting a car call in an elevator system, determining the number of passengers, allocating the elevator car alternatives as serving elevator cars for the passenger. The elevator system including the door sensing device and the surveillance device for monitoring passenger actions, thereby defining the starting point and the final point of a passenger's traveling path. The method also includes calculating a passenger traveling time period, thereby yielding a time forecast of the passenger's arrival time at the waiting lobby. A cost function containing at least one landing time factor is determined for calculating the cost value of each elevator car alternative. The alternative that gives the lowest cost value is allocated as the serving elevator car for the passenger. The elevator system also receives information from external devices via one or more communicative linkages for system operation.

### TECHNICAL FIELD

The present invention relates to an elevator system and methods to automatically prompt car calls, to determine the number of passengers to be provided with serving elevators, to allocate the serving elevators and to cancel prompted car calls on the basis of judgment on passenger actions.

### BACKGROUND ART

A conventional car call is prompted through entry of up/down buttons of a call unit. The elevator system registers a car call after a button has been pushed by the passenger. There are two features used in the elevator system which are believed to reduce passenger waiting time and power consumption. One of which includes a call unit that demands destination floor entry at the time of car call prompting; the elevator system is claimed to reduce operating power consumption. The other feature enables a passenger to prompt car calls through a portable wireless device. Problems arise as in wrong entry of destination floor number and false calls.

### DISCLOSURE OF INVENTION

Hitherto, automation in car call prompting is adopted in detection of passengers in front of the elevator doorways. As an alternative, a car call is limited to be prompted through vocal input from a passenger, or entry with a portable wireless device; however, false calls sporadically arise due to change of passenger actions.

In furtherance to be passenger action based, the elevator system with possession of intelligence ought to receive information including signals and data internal and/or external to the elevator system. The two general areas of interest include reduced passenger waiting time and reduced power consumption.

In this invention, a car call is automatically prompted as the elevator system determines allocation of serving elevator on the basis of information gathered through monitoring passenger actions around the doorways and the waiting lobbies within a building. Other sources of information relate to statistics and archival data. The elevator system cancels a prompted car call once it determines that serving elevator is no longer demanded.

In addition, one or more communicative linkages connecting the elevator system and external devices allow signals/information transport. The elevator system is enabled to control the elevator system operation, as well as doorways and displays at specific landing floors, on the basis of signals/information internal and/or external to the elevator system.

Inventive embodiments are presented in the drawings and best mode of the present application. The inventive content may also consist of several separate inventions. Within the framework of the basic concept of the invention, features of different embodiments of the invention can be applied in conjunction with other embodiments.

Terminology used in this context:
car call: a landing request for the elevator system to schedule at least one elevator car to land at a particular floor within a building containing the elevator system, including information such as but not limited to the requested landing floor, requested elevator traveling direction, destination floor, information pertaining to a virtual/actual doorway, time forecast of passenger arrival at the elevator doorway, and identification of the passenger's personal identification code;
communicative linkage: referring to the ethernet, fiber optical data transport, landline cabling, radio frequency signal transmitting/receiving, and wireless sensor network.
doorway: referring to a door installed passage which is between two territories, or a virtual gateway which differentiates two different positions;
portable wireless device: a transceiver that is capable of transmitting and receiving radio frequency signals, such as but not limited to a cellular phone, a WiFi transceiver, etc.;
state of the elevator system: defining the car call floor-specific traffic intensity, traffic intensities and traffic type prevailing in the elevator system, general power consumption prevailing in the elevator system, and exceptional situations possibly prevailing in the elevator system, such as e.g. system repairs or evacuation situations and other corresponding situations;
traffic intensity: indicating the determined number of passengers in each operating elevator car, the intensity of traffic prevailing in the elevator system in general or on different floors, e.g. light traffic, normal traffic, heavy traffic;
traffic type: indicating the direction of passenger flows generally prevailing in the elevator system, e.g. up-peak, down-peak;
waiting lobby: referring to a lobby or floor where passengers await serving elevators, or correspondingly to a floor or lobby for exit from an elevator car;
operation mode: indicating an electrical device in use and exercising intended functionality;
power reduced mode: indicating a feature of an electrical device defining actively reduced power consumption or power disconnection when not in use;

### DRAWING DESCRIPTIONS

The accompanying drawings, not to scale, serve to depict the control infrastructure and principles of the present invention. However, the invention is not therefore restricted by the supporting drawings to specific apparatuses, technologies, methods or protocols, so long as the operation and performance remain unimpeded and unaltered in principle.

FIG. 1 illustrates an environment with an elevator system having communicatively linked with an external device.

FIG. 2 illustrates the temporal progress of automated allocation of a serving elevator by the system.

FIG. 3 presents a method implemented by the system in a functional block diagram.

### BEST MODE

The elevator system of the invention comprises a control unit, at least one elevator car, one or more door sensing devices monitoring the open-state and the closed-state of the doorways located within a building containing the elevator system, and/or one or more surveillance devices detecting occupancy or portable wireless devices in the vicinity of those doorways. The portable wireless device includes a cellular phone having radio frequency transceiving functionality, or a radio frequency based transceiver, etc. The elevator system is adapted to determine passenger demand for serving elevator in accordance with the signals/information receiving from the door sensing device or the surveillance device, to automate car call prompting and to determine the time at which the passenger arrives at the elevator doorway of the corresponding serving elevator. The elevator system is further adapted to calculate the total cost of each elevator alternative by using the cost function, to allocate for the passenger at least one of the elevator alternatives that gives the lowest cost value as the serving elevator.

In the method of the invention, an elevator system automatically prompts car calls and allocates at least one selected elevator car as the serving elevator. A passenger's traveling path is defined by setting forth a starting point and a final point, the time of passenger arrival at the elevator doorways may be determined on the basis of a calculated passenger traveling time period for the passenger to move from the starting point to the final point. The method also comprises determining a cost function containing one or more landing time factors, which are used for assessment of the elevator alternatives. The cost value of each elevator alternative is calculated in accordance with the cost function, the one or more of which elevator alternatives that give the lowest cost values are allocated as the serving elevators. The lowest cost value is concluded in such a way that the allocated serving elevator stops at the car call floor at a time within the shortest time period before or after the time forecast of passenger arrival at the elevator doorway of the serving elevator, wherein the preset normal door-open time period of the elevator doorway elapses after the passenger's arrival.

In an embodiment of the invention, the landing time factor is determined on the basis of a criterion dependent on the state of the elevator system.

In an embodiment of the invention, the criterion dependent on the state of the elevator system used consists of one or more criteria defining the state of the elevator system or a combination of those criteria, said criteria including: car call floor-specific traffic intensity, traffic type and traffic intensity prevailing in the elevator system, general power consumption prevailing in the elevator system, other uprising situation prevailing in the elevator system.

In another embodiment of the invention, passengers corresponding to an automatically prompted car call not arriving at the elevator doorway of the serving elevator are identified on the basis of signals/information receiving from the surveillance device and/or information external to the elevator system.

In another embodiment of the invention, elevator alternatives which, on the basis of the landing time factor, the passenger would miss the serving elevator are excluded from among the elevator alternatives.

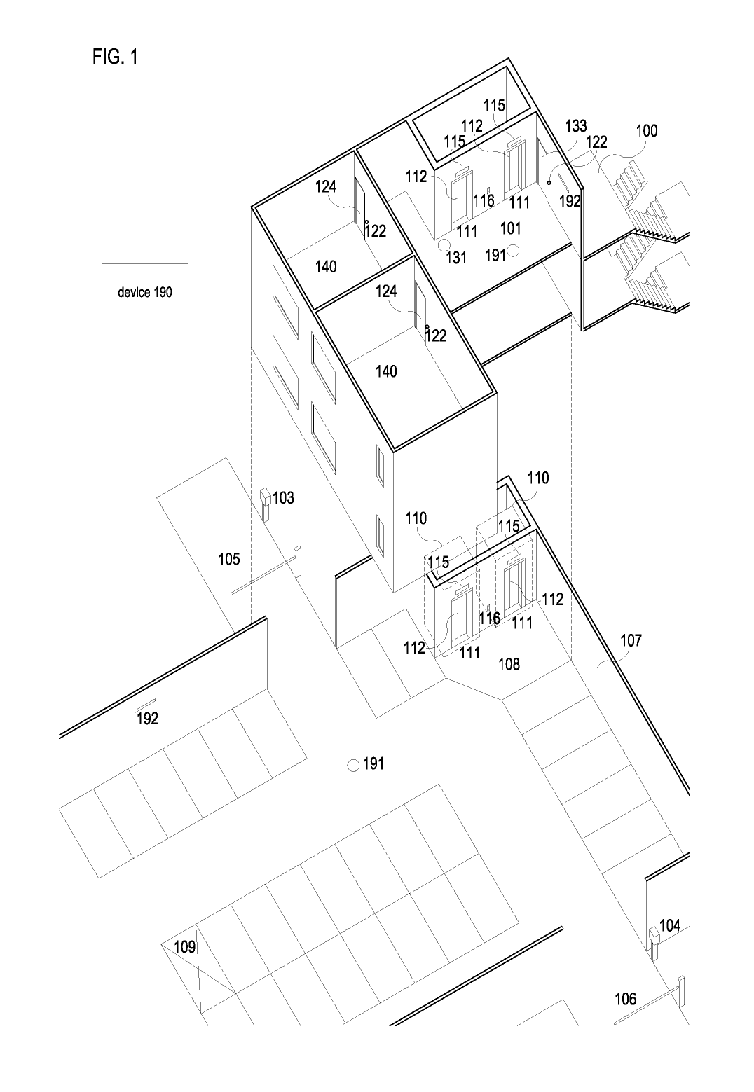

FIG. 1 presents an example of a traffic environment in a building, which arrangement comprises the waiting lobby 108 located at the garage floor 107 and the waiting lobby 101 located at the tenant floor 100. Passengers are served by two elevator cars 110 to commute between the garage floor 107 and a plurality of tenant floors 100.

The elevator system components provided at the tenant floor 100 include elevator doorways 111 equipped with elevator doors 112, floor displays 115 and call unit 116. The door sensing devices 122 are installed for detection of the open-state and closed-state of the doorways 123 of residence units 140 and the emergency doorway 133. The surveillance device 131 monitors said doorways 123. The elevator system is controlled by means of a control unit (not shown in FIG. 1) which communicates with the call units 116, and the elevator car controllers (not shown in FIG. 1) of the elevator cars 110. The control unit is a computer provided with a processor, memory and the required interfaces and software.

An independently operating device 190 is connected to the light fixture 192, the occupancy sensor 191, the entry reader 103, the entry control gate 105, the exit reader 104, and the exit control gate 106, provided at the garage floor 107, as well as, the light fixture 192 and the occupancy sensor 191 provided at the tenant floor 100. The device 190 is communicatively linked with the elevator system.

Having arrived at the entry control gate 105, a passenger in a vehicle (not shown) is detected by the reader 103 either by using buttons or an electrically readable identification means. If access to the garage floor 107 is subject to verification of access rights, then the passenger is required to additionally enter a personal identification code, which may be based on a PIN code manually keyed in or on automatically readable electric identification means. The identification may also contain the location of the corresponding parking space 109 and the residence unit 140 at tenant floor 100. Verification of access rights may be performed either in the device 190, or alternatively in the elevator system.

The control unit receives the information pertaining to passenger entry to the garage floor 107, and the passenger's identification: it retrieves the information of the location of the corresponding parking space 109 and the residence unit 140 at tenant floor 100 for calculation of a passenger traveling time period by setting forth the entry control gate 105 as the starting point and one of the two elevator doorways 111-1, 111-2, of the serving elevator as the final point of the passenger's traveling path. A car call is prompted by the elevator system. A cost function is determined which contains one or more landing time factors for assessment of elevator alternatives. The cost value of each elevator alternative is calculated in conformity with the cost function, the elevator alternative having the lowest cost value is allocated for the passenger as the serving elevator.

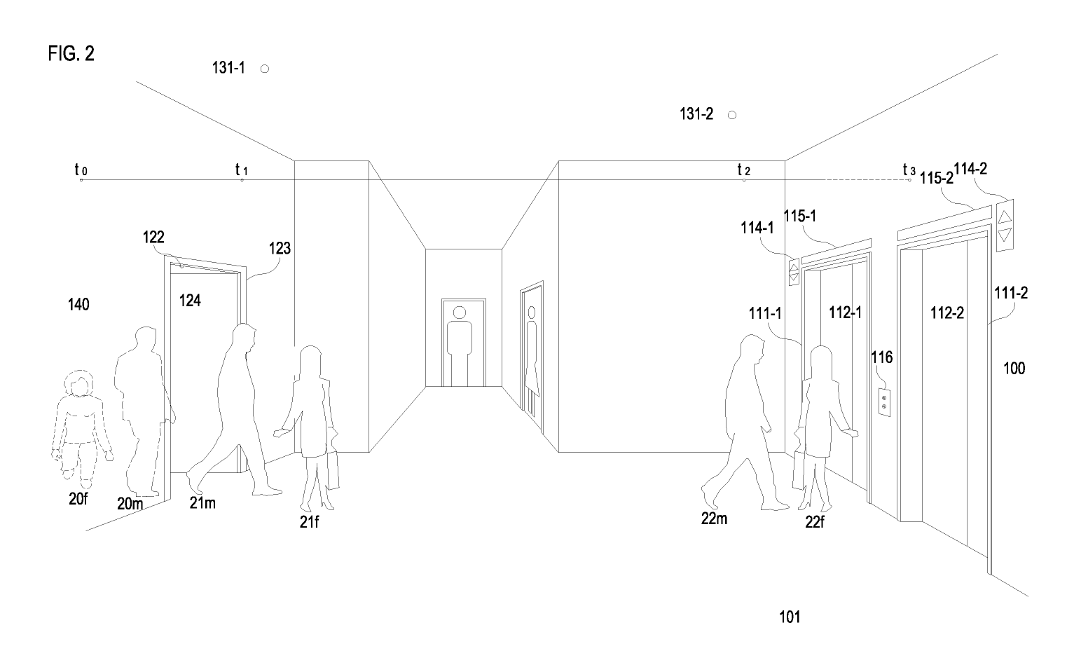

FIG. 2 presents an aspect of an elevator system allocating a serving elevator for passengers, wherein a door sensing device 122 is embedded at the doorway 123 of a tenant unit 140, a surveillance device 131 for monitoring passenger actions around the doorway 123 and/or occupancy in the waiting lobby 101.

The elevator system automatically prompts a car call based on passenger actions, determines the number of passengers, determines the time of their arrival at the elevator doorway 111 of the serving elevator, and allocates one or more selected elevator cars for serving the passengers;
instant t₀:

the first passenger at position 20m opens the door 124, along with the second passenger at position 20f in the tenant unit 140;

the door sensing device 122 detects the open-state of the doorway 123;

the elevator system defines a passenger's traveling path, having set forth the doorway 123 as the starting point and an elevator doorway 111 of the serving elevator as the final point;
walking time t₁−t₀:

the first passenger moves to position 21m, the second passenger moves to position 21f;

the surveillance device 131 detects the two passengers;

the door sensing device 122 detects the closed-state of the doorway 123;

the elevator system determines, on the basis of the signals/information received from the door sensing device 122 and/or the surveillance device 131, there are two passengers, and to allocate a serving elevator—a car call is automatically prompted;

a passenger traveling time period is calculated for determination of the time period required for the passengers to travel through the passenger's traveling path;

the elevator system determines a cost function which contains two landing time factors for assessment of two elevator alternatives;

the elevator system calculates the cost value of each elevator alternative and allocates a selected elevator car having a lower cost value as the serving elevator;
walking time t₂−t₁:

the first passenger moves to position 22m, the second passenger moves to position 22f;

the surveillance device 131-2 detects wireless signals/information receiving from a portable wireless device (not shown) carried by the first passenger;

the serving elevator 110-1 (not shown) lands at the tenant floor 100 after the passenger traveling time period elapses;
boarding time t₃−t₂:

the elevator doors 112-1 are opened (not shown);

the first passenger and the second passenger enter through the elevator doorway 111-1 and board the serving elevator 110-1;

the surveillance device 131-2 receives no more wireless signals/information and detects no more occupancy;

allocation of serving elevator to the tenant floor 100 is completed;
journey time t₃+:

the elevator doors 112-1 are closed when the preset normal door-open time period elapses;

the serving elevator 110-1 travels to the input destination floors;

a control device determines, on the basis of detection through sensors, that the waiting lobby 101 is unattended with passengers and sends the signals/information to the elevator system via a communicative linkage;

the elevator system switches hall lanterns 114-1, 114-2, floor displays 115-1, 115-2, and call unit 116 from an operation mode to a power reduced mode.

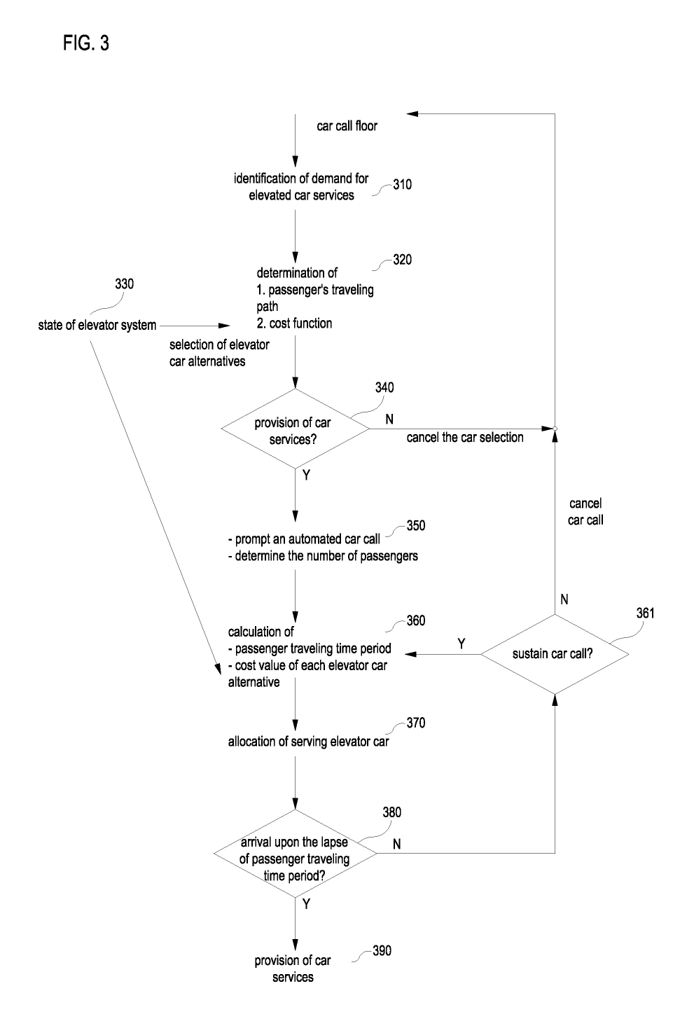

FIG. 3 presents a method implemented by the system in a functional block diagram.

In block 310, the signals/information sent by a monitoring point (such as a door sensing device or a surveillance device), indicating a doorway changes from a closed-state to an open-state and/or a passenger at said doorway, is received along with the identifier of the monitoring point. The elevator system retrieves information in compliance with the identifier from a storage means; said information attributes to the uniqueness of a doorway, such as the location and the users of said doorway. In furtherance, through a radio frequency transceiver based surveillance device, the elevator system transmits signals/information to a portable wireless device, and receives from it the identifier and other information including real-time data which attributes to its uniqueness. The signals/information may also be tagged with identification of the passenger's personal identification code; the elevator system storage means also contains stored information about passengers' destination data.

In block 320, the elevator system defines a passenger's traveling path, by setting forth the starting point a doorway corresponding to an automatically prompted car call, to the final point an elevator doorway of the allocated serving elevator. In other embodiments, the elevator system may set forth any location within a building containing the elevator system as the starting point. A cost function is determined taking into account at least one landing time factor, which is used for assessing the elevator alternatives. The landing time factor value compliant with the scheduled landing time at each landing floor of an elevator alternative is determined on the basis of a criterion dependent on the state of the elevator system.

Block 330 contains some of those criteria using real-time operation data such as car call floor-specific traffic intensity, traffic type and traffic intensity prevailing in the elevator system, general power consumption prevailing in the elevator system, other uprising situation prevailing in the elevator system. The car call floor-specific traffic intensities are determined on the basis of a determined number of passengers, sustained car calls prompted through automation and entered by passengers. To identify exceptional situations in the elevator system, the block comprises monitoring of signals internal and/or signals external to the elevator system which are indicative of exceptional situations in the elevator system.

In block 340, the elevator system obtains signals/information sent by one or more monitoring devices indicating that the doorway resumes a closed-state, and/or, the passenger is in the waiting lobby. The elevator system determines to allocate at least one serving elevator for the detected passenger and automatically prompts a car call. Alternatively, the elevator system rules out provision of serving elevator.

In block 350, the elevator system determines the number of passengers, by using methods such as timing the duration of the open-state of the doorway, processing the images captured with an image capturing device, or monitoring the number of radio frequency signals received from portable wireless devices, and so forth.

In block 360, a passenger traveling time period is calculated taking into account the distance of the passenger's traveling path, the determined number of passengers, and the car call floor-specific traffic intensity. The landing time factor of each elevator alternative included in the cost function is determined taking into account the state of the elevator system, as mentioned in block 320. The elevator system calculates the cost value of each elevator alternative in compliance with the cost function. Those elevator alternatives in which, considering the forecasted landing times at the car call floor, the passenger is likely to miss the serving elevator are excluded in the calculation of the cost value. The cost values of the elevator alternatives are compared to each other and one or more of the elevator alternatives possessing the lowest cost values are allocated as the serving elevators in response to an automatically prompted car call.

In block 370, the elevator system implements allocation of the serving elevators by scheduling the serving elevators to stop at the corresponding car call floor. It is inappropriate to settle on car landing immediately when a car call is automatically prompted; instead, it suffices to schedule the landing time of the serving elevator having the lapse of the preset normal door-open time period of the corresponding elevator doorway within the minimum time period after the passenger's arrival.

In block 380, to determine the time of passenger arrival at the elevator doorways and detection of belated passengers, the waiting lobby is monitored with at least one monitoring device. If the passenger comes too late to catch the serving elevator, a car call may be prompted through passenger entry by using a call device provided in the waiting lobby; alternatively, a car call is automatically prompted on the basis of signals/information received from the monitoring devices installed in the waiting lobby.

In an alternative embodiment, the passengers are not detected when the passenger traveling time period elapses. A decision is to be made for sustainment or cancellation of the prompted car call in block 361. The cost values of the elevator alternatives are recalculated in accordance with a sustainment. On the other hand, the prompted car call is canceled.

In block 390, one or more serving elevators are provided in accordance with the determined number of passengers of a car call. The elevator determines on the basis of processed signals/information receiving from the surveillance devices when the passengers are in the waiting lobby of the landing floor. To guide those passengers to the elevator doorways of the allocated serving elevators and acknowledge the passengers upon arrival of the serving elevators, the elevator system sends signals/information to the guiding devices. The guiding devices include the passenger carried portable wireless devices, displays and/or sound reproduction devices.

It is apparent to those who are skilled in the art that variations and differences in embodiments of the invention are not exclusively limited to the exemplary embodiments described above, but they may be varied within the scope of the claims.

The invention claims:

1. An elevator system for allocating at least one serving elevator in response to each prompted car call, said elevator system including:
at least one control unit;
at least one elevator car;
one or more communicatively linked door sensing devices; and/or
one or more communicatively linked surveillance devices;
a car call generator that prompts car calls and cancels prompted car calls;
a calculation portion that determines the starting point and final point of a passenger's traveling path in accordance with a prompted car call and calculates at least one corresponding passenger traveling time period;
a cost function generator that generates a cost function for the elevator alternatives, said cost function containing at least one landing time factor;
a landing time factor determination unit that determines a value of the at least one landing time factor corresponding to each elevator alternative in the cost function;
a cost calculator that calculates the cost value of each elevator alternative by using the generated cost function;
a response portion that allocates, in response to a prompted car call, at least one selected elevator car;
a door control portion that controls opening/closing operations of the elevator doorway.

2. An elevator system according to claim 1, wherein the door sensing device, which is installed at a doorway in a building containing the elevator system, detects the open-state, the duration of the open-state, and the closed-state of said doorway, the door sensing device including:
a compression type sensor; or,
a magnetic type sensor; or,
a door control device; or,
an audio senor; or,
an electronic door lock.

3. An elevator system according to claim 1, wherein the surveillance device, which detects occupancy, or transmits signals/information and receives signals/information from a radio frequency based portable wireless device, is installed at or around a doorway in a building containing the elevator system, the surveillance device including:
a passive infrared (“PIR”) sensor that detects occupancy;
a radio frequency based transceiver that transmits/receives radio frequency signals;
a smart floor that detects loads;
an image capturing device including the cmos sensor.

4. The elevator system of claim 1, wherein the elevator system is further communicatively linked with one or more devices that are external to the elevator system via at least one communicative linkage, comprising:
sending signals/information to said one or more devices;
receiving and/or storing in a storage means the signals/information sent from said one or more devices.

5. The elevator system of claim 4, wherein said one or more devices including a portable wireless device, a lighting control device, and/or a plurality of communicatively linked processor mounted devices attributing to a lighting control system installed in a building containing the elevator system.

6. An elevator system according to claim 1, wherein the car call generator determines to prompt a car call in accordance with signals receiving from the door sensing device.

7. An elevator system according to claim 1, wherein the car call generator determines to prompt a car call in accordance with signals/information receiving from the surveillance device.

8. An elevator system according to claim 1, wherein the elevator system further comprises a monitoring portion that determines, on the basis of the duration of the open-state of the doorway wherein the door sensing device is installed, the number of passengers corresponding to a prompted car call.

9. An elevator system according to claim 8, wherein said monitoring portion further determines said number of passengers based on processing signals/information sent by the surveillance device, including:
processing the signals received from the PIR sensor; or,
processing the signals/information received from the portable wireless device; or,
processing the signals received from the smart floor; or,
processing the images captured by the image capturing device.

10. An elevator system according to claim 1, wherein the calculation portion calculates at least one passenger traveling time period, upon the lapse of which the passenger is expected to arrive at the final point of said passenger's traveling path.

11. An elevator system according to claim 1, wherein the landing time factor determination unit determines the value of the at least one landing time factor based on a criterion dependent on the state of the elevator system.

12. An elevator system according to claim 11, wherein said criterion dependent on the state of the elevator system includes one or more criteria defining the state of the elevator system or a combination of them, said criteria including: car call floor-specific traffic intensity, traffic intensity prevailing in the elevator system, traffic type prevailing in the elevator system, general power consumption prevailing in the elevator system, exceptional situation prevailing in the elevator system.

13. An elevator system according to claim 1, wherein the response portion allocates, in response to a prompted car call, from the elevator alternatives having the lowest calculated cost values, at least one elevator alternative as the serving elevator, having the smallest difference in time between the corresponding car call floor landing time, and the time forecast of passenger arrival at the elevator doorway of said elevator alternative wherein the preset normal door-open time period of said elevator doorway elapses after said time forecast.

14. An elevator system according to claim 1, wherein the door control portion controls opening/closing operations of the elevator doorway of a serving elevator.

15. An elevator system according to claim 1, wherein the car call generator determines to cancel a prompted car call on the basis of passengers conditions, said passenger conditions including: one or more passenger traveling time periods, signals receiving from one or more door sensing devices, signals/information receiving from one or more surveillance devices.

16. A method for prompting car calls and allocating serving elevators in an elevator system, the method comprising:
prompting car calls;
determining the starting point and final point of a passenger's traveling path corresponding to a prompted car call;
determining at least one passenger traveling time period corresponding to a prompted car call;
determining the number of passengers corresponding to a prompted car call;
determining the number of passengers to be served with serving elevators;
determining a cost function for the elevator alternatives, said cost function containing at least one landing time factor;
determining the value of the at least one landing time factor corresponding to each elevator alternative in the cost function;
calculating the cost value of each elevator alternative by using the cost function;
allocating, in response to a prompted car call, at least one selected elevator car;
controlling opening/closing operations of the elevator doorway;
cancelling prompted car calls.

17. A method according to claim 16, determining to prompt a car call in accordance with the signals receiving from the door sensing device.

18. A method according to claim 16, determining to prompt a car call in accordance with the signals/information receiving from the surveillance device.

19. A method according to claim 16, further comprising determining, on the basis of the duration of the open-state of the doorway wherein the door sensing device is installed, the number of passengers corresponding to a prompted car call.

20. A method according to claim 16, further comprising determining said number of passengers based on processing the signals/information sent by the surveillance device, including:
processing the signals received from the PIR sensor; or,
processing the information received from the portable wireless device; or,
processing the information received from the smart floor; or,
processing the images captured by the image capturing device.

21. A method according to claim 16, comprising calculating at least one passenger traveling time period, upon the lapse of which the passenger is expected to arrive at the final point of said passenger's traveling path.

22. A method according to claim 21, further comprising determining, based on the said at least one passenger traveling time period, at least one time forecast, which said passenger is expected to arrive at the elevator doorway of a serving elevator.

23. A method according to claim 16, determining the value of the at least one landing time factor including determining the value of said landing time factor based on a criterion dependent on a state of the elevator system.

24. A method according to claim 23, wherein said criterion dependent on the state of the elevator system includes one or more criteria defining the state of the elevator system or a combination of them, said criteria including: car call floor-specific traffic intensity, traffic intensity prevailing in the elevator system, traffic type prevailing in the elevator system, general power consumption prevailing in the elevator system, exceptional situation prevailing in the elevator system.

25. A method according to claim 16, comprising allocating, in response to a prompted car call, from the elevator alternatives having the lowest calculated cost values, at least one elevator alternative as the serving elevator, having the smallest difference in time the corresponding car call floor landing time, and the time forecast of passenger arrival at the elevator doorway of said elevator alternative wherein the preset normal door-open time period of said elevator doorway elapses after said time forecast.

26. A method according to claim 16, comprising holding the elevator doorway of a serving elevator in a door-open state until a passenger traveling time period elapses, when the serving elevator stops at a car call floor and a door-opening operation of the elevator doorway is completed before the passenger traveling time period elapses.

27. A method according to claim 26, further comprising holding the elevator doorway of a serving elevator in a door-closed state until an operation starting time instant set on a basis of the lapse of a passenger traveling time period, when the serving elevator stops at a car call floor before the passenger traveling time period elapses.

28. A method according to claim 16, determining to cancel a prompted car call on the basis of passenger conditions, said passenger conditions including: one or more passenger traveling time periods, signals receiving from one or more door sensing devices, signals/information receiving from one or more surveillance devices.

29. A computer readable medium having embodied thereon a program that, when executed in or with an elevator system, said elevator system including at least one elevator car, causes said elevator system to perform a method for allocating at least one serving elevator in response to a prompted car call, the method comprising:
prompting car calls;
storing with a storage means the information pertaining to and attributing to the uniqueness of at least one doorway in a building containing the elevator system;
retrieving from said storage means the information pertaining to said at least one doorway corresponding to a prompted car call;
storing with a storage means the information pertaining to and attributing to the uniqueness of one or more radio frequency based portable wireless devices;
receiving signals/information from said one or more portable wireless devices;
sending signals/information to said one or more portable wireless devices;
determining the starting point and final point of a passenger's traveling path in accordance with a prompted car call;
determining at least one passenger traveling time period corresponding to a prompted car call;
determining the number of passengers corresponding to a prompted car call;
determining a cost function for the elevator alternatives, said cost function containing at least one landing time factor;
determining the value of the at least one landing time factor corresponding to each elevator alternative in the cost function;
calculating the cost value of each elevator alternative by using the cost function;
allocating, in response to a prompted car call, at least one selected elevator car;
controlling opening/closing operations of the elevator doorways;
cancelling prompted car calls.

30. The method of claim 6, further comprising an elevator system sending signals/information to one or more communicatively linked devices that are external to an elevator system, the signals/information including: the car call floor number, the destination floor number, the elevator doorway of the serving elevator, an alert of landing of serving elevator, the real-time data pertaining to said state of the elevator system, the schedule of one or more elevator cars in operation mode, and the door operations corresponding to door opening/closing of one or more elevator doorways.

31. The method of claim 30, further comprising controlling, on the basis of signals/information receiving from one or more communicatively linked devices that are external to the elevator system, one or more apparatuses of the elevator system, comprising:
determining and switching, based on the commands or signals/information sent from the one or more communicatively linked devices, from an operation mode to a power reduced mode, or, from a power reduced mode to an operation mode, at least one control unit of the elevator system;
determining and switching, based on the commands or signals/information sent from the one or more communicatively linked devices, from an operation mode to a power reduced mode, or, from a power reduced mode to an operation mode, one or more apparatuses of said elevator system, said one or more apparatuses including: floor displays, call units, and lamps installed in one or more waiting lobbies, door sensing devices, surveillance devices, elevator cars;
determining and controlling opening/closing operations of one or more elevator doorways.
